(19) United States
(12) Patent Application Publication
(10) Pub. No.: US 2016/0092910 A1
(43) Pub. Date: Mar. 31, 2016

(54) Marketing/Referral Card/s

(71) Applicant: Bryan Philip Dugan, Laramie, WY (US)

(72) Inventor: Bryan Philip Dugan, Laramie, WY (US)

(21) Appl. No.: 14/845,901

(22) Filed: Sep. 4, 2015

Related U.S. Application Data
(60) Provisional application No. 62/057,349, filed on Sep. 30, 2014.

(51) Int. Cl. G06Q 30/02

(52) U.S. Cl. CPC G06Q 30/0241

(57) ABSTRACT

Techniques for gathering referral information and displaying business information. In one example, you may have it made so that the business card or marketing card can separate from the referral portion of the card using perforation to neatly separate them, all of which can be put into your pocket due to the size. And putting scores on the referral part of the card so that the card can fold to the size of a business card for easy transporting.

### FIELD/BACKGROUND

The present invention generally relates to the area of gathering referrals and distributing marketing material. And allows individuals multiple options to deliver referrals.

### SUMMARY OF INVENTION

A business card carries not only contact information but also represents an image of business. Exchanging business cards thus becomes a meeting protocol between two people when the two meet for the first time. As such there are approximately 15 billion business cards that are exchanged between hands each year and a big part of this is that the size is small enough to fit into your pocket. A marketing card (the marketing/referral card) has information that is pertinent to a group of people to display information, logos or any information that makes locating and understanding the business easy. Referrals are also a major part of everyone's business and referrals can be gathered in many different methods, but this method of having both a business card and a referral card combined or potentially separated allows an individual to have both worlds of the business. And because the post office has requirements on size one must be able to unfold these for the convenience that the mail allows them by just dropping it in the mail after a meeting. This method also allows them to receive a gift card in some situations if they refer someone. The ultimate goal of having this is to gather referral information and in some cases give them your business information. And in some cases they can later send you the referral portion if they need time Marketing/Referral Card/s gives multiple options.

### BRIEF DESCRIPTION/DRAWING FIGURES

This section is for the purpose of summarizing some aspects of the present invention and to briefly introduce some preferred embodiments. Simplifications or omissions in this section as well as in the abstract or the title of this disclosure may be made to avoid obscuring the purpose of this section and the abstract/title. Such simplifications or omissions are not intended to limit the scope of the present invention.

The present invention is generally related to techniques for gathering referrals and giving your information. Depending on implementation there are a variety of ways to use these.

According to one aspect of the present invention, having a both a business card or marketing card and a referral card combined can allow a person to tear away the pieces and gather information and give the marketing card or business card; all of which can be put into your pocket due to the size.

According to another aspect of the present invention, you may have it made so that the business card or marketing card can separate from the referral portion of the card using perforation to neatly separate them; all of which can be put into your pocket due to the size.

According to another aspect of the present invention, you may have it made so that the business card or marketing card can separate from the referral portion of the card using perforation to neatly separate them; all of which can be put into your pocket due to the size. And putting scores on the referral part of the card so that the card can fold to the size of a business card for easy transporting.

According to another aspect of the present invention, you may have it made so that the business card or marketing card can separate from the referral portion of the card using perforation to neatly separate them all of which can be put into your pocket due to the size. And putting scores on the referral part of the card so that the card can fold to the size of a business card for easy transporting. And having the size of the referral portion of the card set to a size that is allowed by the Postal Service to allow for delivery using methods like business reply mail, standard mail and so on.

According to another aspect of the present invention, you may have it made so that the business card or marketing card can separate from the referral portion of the card using perforation to neatly separate them all of which can be put into your pocket due to the size. And putting scores on the referral part of the card so that the card can fold to the size of a business card for easy transporting. And having the size of the referral portion of the card set to a size that is allowed by the Postal Service to allow for delivery using methods like business reply mail, standard mail and so on. Using a standard envelope size to put the entire piece in, for easy return by mail, and keeping information confidential.

### BRIEF DESCRIPTION OF THE DRAWINGS

These and other features, aspects, and advantages of the present invention will become better understood with regard to the following description, appended claims, and accompanying drawings where:

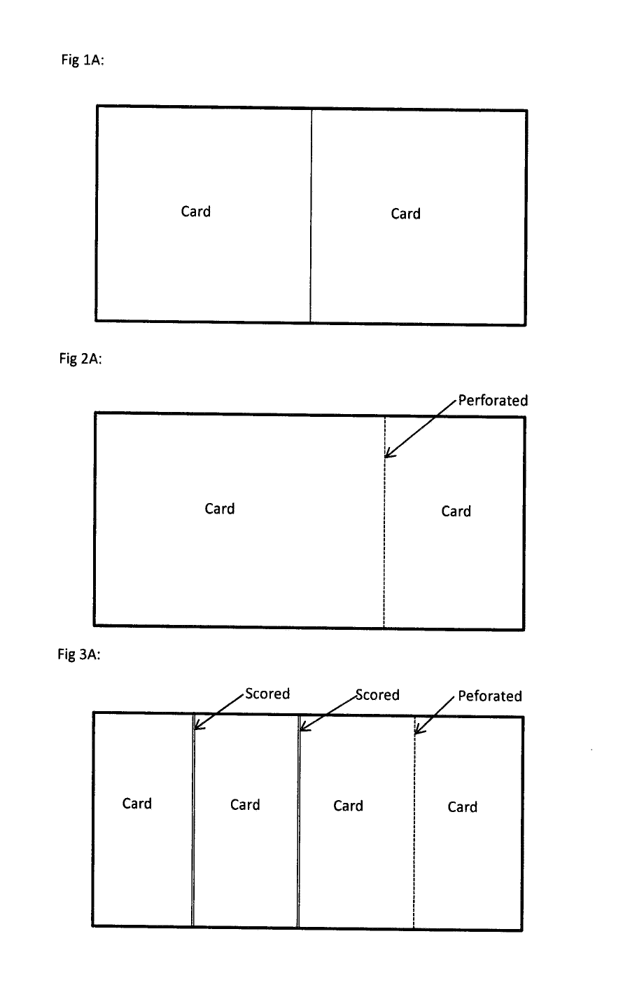

FIG. 1A shows a format in which the present invention may be practiced in accordance with one embodiment thereof;

FIG. 2A shows a system configuration in which the present invention may be practiced in accordance with one embodiment thereof;

FIG. 3A shows a system configuration in which the present invention may be practiced in accordance with one embodiment thereof;

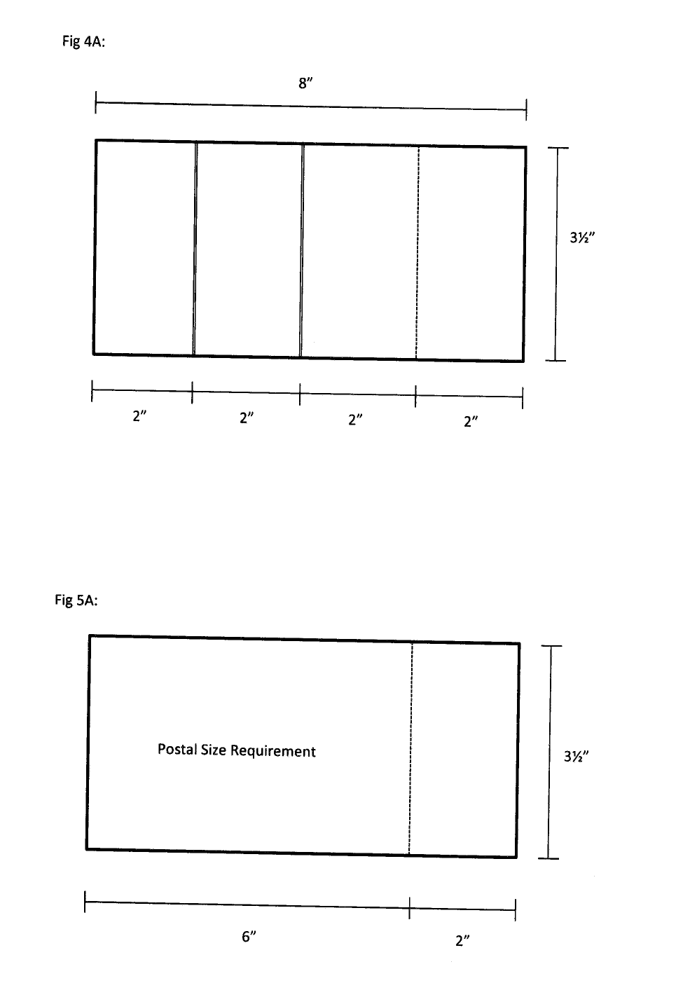

FIG. 4A shows a system configuration in which the present invention may be practiced in accordance with one embodiment thereof;

FIG. 5A shows a system configuration in which the present invention may be practiced in accordance with one embodiment thereof.

I claim:

1. A marketing/referral card is a business card or marketing card and a post card combined

2. The marketing/referral card in claim 1: could be separated with a perforation

3. The marketing/referral card in claim 1: could have two additional scores that help the postcard fold into a business card size, along with the perforated portion

4. The marketing/referral card in claim 1: might have dimensions that as a whole are three and a half inches by eight inches

5. The marketing/referral card in claim 1: might be divided using the business card size (3 and ½ inches by 2 inches) by the slightly over the postage size of (3 and ½ inches by 6 inches)

6. The marketing/referral card in claim 1: could have writing expressing different intentions for the following situations 1) Using the marketing/referral card as a pad of paper to gather referrals and tear away the card that has marketing information to give to them 2) Giving the marketing/referral card with business reply artwork on it to put into the mail in case they need a chance to decide on referrals and 3) The ability to fold the marketing/referral card and put it in your pocket/wallet easily and thus making it easy for them to also put in their pocket/wallet to make it a convenience on whether they need to mail it.
